(19) United States
(12) Patent Application Publication
(10) Pub. No.: US 2021/0223090 A1
(43) Pub. Date: Jul. 22, 2021

(54) METHOD FOR CALCULATING PIPING CAPACITY AND CALIBRATOR FOR FLOW RATE CONTROL INSTRUMENT OR FLOW RATE MEASURING INSTRUMENT

(71) Applicant: HORIBA STEC, Co., Ltd., Kyoto-shi, Kyoto (JP)

(72) Inventor: Yasuhiro ISOBE, Kyoto-shi (JP)

(21) Appl. No.: 16/972,195

(22) PCT Filed: Jun. 10, 2019
(86) PCT No.: PCT/JP2019/022916

§ 371 Date: Dec. 4, 2020

(30) Foreign Application Priority Data
Jun. 15, 2018 (JP) 2018-114914

(51) Int. Cl. G01F 25/00; G01F 17/00

(52) U.S. Cl. CPC G01F 25/0007; G01F 17/00

(57) ABSTRACT

In order to calibrate a flow rate instrument, the following is provided: introducing a fluid controlled by a flow rate control instrument to a certain set flow rate into a container via a piping member and calculating a first time rate of change in pressure in the container; introducing a fluid controlled by the flow rate control instrument to the set flow rate into a container via a piping member while making any of a capacity of the container into which the fluid is introduced, a number of containers into which the fluid is introduced, a temperature of the fluid, and a type of the fluid different, and calculating a second time rate of change in pressure in the container; and calculating a capacity of the piping member based on the first time rate of change in pressure and the second time rate of change in pressure.

### TECHNICAL FIELD

The present invention relates to a method for calculating the capacity of a piping member connected to a flow rate control instrument such as a mass flow controller or a flow rate measuring instrument such as a mass flow meter in order to calibrate the flow rate control instrument or the flow rate measuring instrument, and to a calibrator for calibrating a flow rate control instrument such as a mass flow controller or a flow rate measuring instrument such as a mass flow meter.

### BACKGROUND ART

As this type of calibrator, a calibrator called a pressure rate-of-rise flow rate calibrator (ROR calibrator) is available. A flow rate control instrument is adjusted by calibrating the actual flow rate obtained by using the ROR calibrator and the set flow rate of the flow rate control instrument so that the actual flow rate and the set flow rate match.

Specifically, a ROR calibrator is configured as follows: a container with a known capacity is provided with a thermometer and a pressure meter, and a flow rate control instrument supplies the container with a fluid controlled to a certain set flow rate. The ROR calibrator is configured to calculate the actual flow using the rate of rise in pressure in the container at that time, the capacity of the container, and the temperature of the fluid.

Here, accurate calculation of the actual flow rate requires consideration of the capacity of a piping member connecting the container and the flow rate control instrument, in addition to the capacity of the container. However, the size and so forth of the piping member vary depending on the location of the flow rate control instrument, and, in order to accurately adjust the flow rate control instrument, it is necessary to obtain the capacity of the piping member at the location.

As a method of obtaining the capacity of the piping member, there is a method using Boyle-Charles' law, as discussed in PTL 1. Specifically, a piping member is provided with a thermometer and a pressure meter, and the piping member is filled with gas. By introducing the gas into a container, the capacity of the piping member is calculated by utilizing the fact that the pressure and the capacity are inversely proportional under the condition of constant temperature before and after the gas is introduced.

However, this method requires to provide the piping member with a pressure meter and a thermometer, and furthermore, improvement in the adjustment accuracy requires calibration of the pressure meter and the thermometer. Accordingly, the flow rate control instrument may not be easily and accurately adjusted.

### CITATION LIST

### Patent Literature

PTL 1: Japanese Unexamined Patent Application Publication No. 2018-44887

### SUMMARY OF INVENTION

### Technical Problem

The present invention has been made to solve the above-described problems, and it is a main object thereof to enable easy and accurate adjustment of a flow rate control instrument.

### Solution to Problem

That is, a calculation method according to the present invention includes: a first calculation step of introducing a fluid controlled by a flow rate control instrument to a certain set flow rate into a container via a piping member and calculating a time rate of change in pressure in the container; a second calculation step of introducing a fluid controlled by the flow rate control instrument to the set flow rate into a container via a piping member while making any of a capacity of the container into which the fluid is introduced, a number of containers into which the fluid is introduced, a temperature of the fluid, and a type of the fluid different from the first calculation step, and calculating a time rate of change in pressure in the container; and a pipe capacity calculation step of calculating a capacity of the piping member based on the time rate of change in pressure calculated in the first calculation step and the time rate of change in pressure calculated in the second calculation step.

Here, let the capacity of the container be V, the capacity of the piping member be X, the temperature of the fluid be T, a correction coefficient due to the compressibility coefficient of the fluid be C_{comp}, and a correction coefficient due to the apparatus be C_{KFF}. Then, the flow rate Q of the fluid is represented by equation (1) below using the time rate of change in pressure in the container dp/dt.

From this, according to the above-described calibration method according to the present invention, by substituting the time rates of change in pressure calculated in the first calculation step and the second calculation step into equation (1) while making any of the capacity of the container, the number of containers, the temperature of the fluid, and the type of the fluid different between the first calculation step and the second calculation step, simultaneous equations in which the flow rate Q of the fluid and the capacity X of the piping member are unknowns may be obtained.

In the pipe capacity calculation step, by substituting V, T, C_{comp}, and C_{KFF}, which are the measured values and known values, into the simultaneous equations, the simultaneous equations may be solved for the capacity X of the piping member. This may enable easy and accurate adjustment of the flow rate control instrument without providing a pressure meter, a thermometer, and the like for the piping member.

$$\begin{matrix}[ Eq . 1 ] & \\ Q = \frac{d p}{d t} \times ( V + X ) \times \frac{60}{760} \times \frac{273.15}{273.15 + T} \times {C}_{comp} \times {C}_{KFF} & ( 1 )\end{matrix}$$

As a specific method for making the capacity of the container different, the following method may be mentioned: a first container and a second container having different capacities are connected in parallel; in the first calculation step, a fluid controlled by the flow rate control instrument to the set flow rate is introduced into the first container without being introduced into the second container; and, in the second calculation step, a fluid controlled by the flow rate control instrument to the set flow rate is introduced into the second container without being introduced into the first container.

As a specific method for making the number of containers different, the following method may be mentioned: a first container and a second container are connected in series; in the first calculation step, a fluid controlled by the flow rate control instrument to the set flow rate is introduced into the first container without being introduced into the second container; and, in the second calculation step, a fluid controlled by the flow rate control instrument to the set flow rate is introduced into the first container and the second container.

It is preferable that the calculation method further include an actual flow rate calculation step of calculating an actual flow rate of the fluid controlled by the flow rate control instrument using the capacity of the piping member calculated in the pipe capacity calculation step.

In this way, by substituting the calculated capacity X of the piping member into equation (1) mentioned above, the actual flow rate Q of the fluid which takes into consideration the capacity X of the piping member may be calculated, and the flow rate control instrument may be accurately adjusted.

In addition, a calibrator according to the present invention is a calibrator to which a flow rate control instrument is connected with a piping member interposed therebetween, including: at least two containers into which a fluid controlled by the flow rate control instrument to a certain set flow rate is introduced. A capacity of a container or a number of containers into which a fluid controlled by the flow rate control instrument to the set flow rate is configured to be changeable.

With such a calibrator, the same or similar effects to the above-described calibration method may be achieved.

Furthermore, a calculation method according to the present invention includes: a first calculation step of introducing a fluid whose flow rate is measured by a flow rate measuring instrument into a container via a piping member and calculating a time rate of change in pressure in the container; a second calculation step of introducing a fluid whose flow rate is measured by the flow rate measuring instrument into a container via a piping member while making any of a capacity of the container into which the fluid is introduced, a number of containers into which the fluid is introduced, a temperature of the fluid, and a type of the fluid different from the first calculation step, and calculating a time rate of change in pressure in the container; and a pipe capacity calculation step of calculating a capacity of the piping member based on the time rate of change in pressure calculated in the first calculation step and the time rate of change in pressure calculated in the second calculation step.

With such a method, the flow rate measuring instrument may be easily and accurately adjusted, as in the above-described flow rate control instrument calibration method.

### Advantageous Effects of Invention

According to the present invention configured as above, a flow rate control instrument or a flow rate measuring instrument may be adjusted more easily and accurately as compared to the related art.

### BRIEF DESCRIPTION OF DRAWINGS

FIG. 1 is a diagram schematically illustrating the configuration of a calibrator of the present embodiment.

FIG. 2 is a flowchart illustrating a calibration method of the present embodiment.

FIG. 3 is a diagram schematically illustrating the configuration of a calibrator of another embodiment.

FIG. 4 is a flowchart illustrating a calibration method of another embodiment.

FIG. 5 is a flowchart illustrating a calibration method of another embodiment.

FIG. 6 is a flowchart illustrating a calibration method of another embodiment.

### DESCRIPTION OF EMBODIMENTS

Hereinafter, an embodiment of a flow rate control instrument calibration method according to the present invention will be described with reference to the drawings.

First, the overall configuration of a calibration system 100 that calibrates a flow rate control instrument MFC will be described.

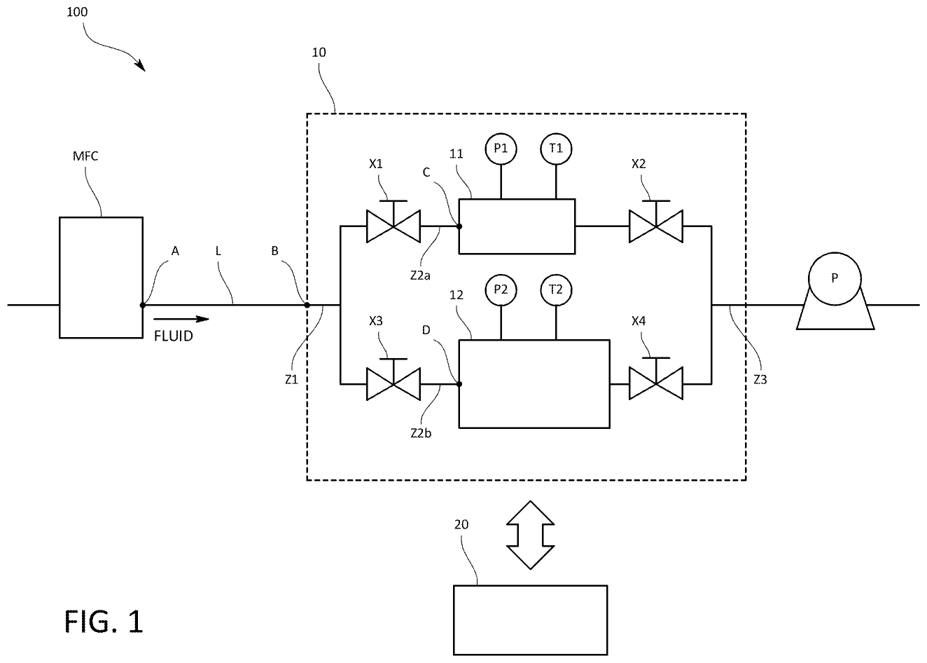

The calibration system 100 of the present embodiment is for calibrating the flow rate control instrument MFC such as a mass flow controller. As illustrated in FIG. 1, the calibration system 100 includes a calibrator 10 connected to the flow rate control instrument MFC, a piping member L connecting the flow rate control instrument MFC and the calibrator 10, a suction pump P such as a vacuum pump connected downstream of the calibrator 10, and an information processing apparatus 20 that exchanges signals with the calibrator 10.

The piping member L has two ends. An opening at one end is connected to an outlet port A of the flow rate control instrument MFC, and an opening at the other end is connected to an inlet port B of the calibrator 10.

Note that the piping member L discussed here is one whose internal space is formed as a flow path where fluid flows. The piping member L corresponds to a concept including not only the piping itself but also a manifold block and a gas panel where an internal flow path is formed. A combination of piping, a manifold block, and a gas panel also serves as the piping member L.

The calibrator 10 may be called a pressure rate-of-rise flow rate calibrator (ROR calibrator), and specifically includes at least two containers 11 and 12. The calibrator 10 is configured such that a fluid controlled by the flow rate control instrument MFC to a certain set flow rate is introduced into these containers 11 and 12.

The calibrator 10 here includes the first container 11 and the second container 12 having different capacities, and the first container 11 and the second container 12 are connected in parallel. The first container 11 and the second container 12 have known capacities. The first container 11 is provided with a first pressure meter P1 and a first thermometer T1, and the second container 12 is provided with a second pressure meter P2 and a second thermometer T2. The measured values of the first pressure meter P1, the first thermometer T1, the second pressure meter P2, and the second thermometer T2 are output to the later-described information processing apparatus 20.

The calibrator 10 of the present embodiment is configured such that the capacity of a container into which a fluid controlled by the flow rate control instrument MFC to a certain set flow rate is introduced is changeable. Specifically, the calibrator 10 is configured such that a fluid is introduced alternatively into either the first container 11 or the second container 12.

More specifically, the calibrator 10 includes an upstream main pipe Z1 where the above-mentioned inlet port B is formed and which is connected to the piping member L, a plurality of branch pipes Z2 branched from the upstream main pipe Z1, and a downstream main pipe Z3 where the plurality of branch pipes Z2 meet. Here, two branch pipes Z2 are provided. A first branch pipe Z2a is provided with the first container 11, and a second branch pipe Z2b is provided with the second container 12. In this configuration, the capacity from the inlet port B to a connection point C between the first branch pipe Z2a and the first container 11 is known, and the capacity from the inlet port B to a connection point D between the second branch pipe Z2b and the second container 12 is known.

On-off valves X1 and X2 are respectively provided upstream and downstream of the first container 11 in the first branch pipe Z2a, and on-off valves X3 and X4 are respectively provided upstream and downstream of the second container 12 in the second branch pipe Z2b. Hereinafter, for convenience of explanation, the on-off valve upstream of the first container 11 is referred to as the first on-off valve X1; the on-off valve downstream of the first container 11 is referred to as the second on-off valve X2; the on-off valve upstream of the second container 12 is referred to as the third on-off valve X3; and the on-off valve downstream of the second container 12 is referred to as the fourth on-off valve X4. In this configuration, the capacity from the first container 11 to the second on-off valve X2 is known, and the capacity from the second container 12 to the fourth on-off valve X4 is known.

Physically speaking, the information processing apparatus 20 is a general-purpose or dedicated computer provided with a CPU, memory, an input/output interface, and so forth. By allowing the CPU and one or more peripheral devices to cooperate with one another in accordance with a certain program stored in a certain area of the memory, the information processing apparatus 20 receives signals indicating the measured values of the first pressure meter P1, the first thermometer T1, the second pressure meter P2, and the second thermometer T2 to perform various types of arithmetic processing, and controls each of the above-mentioned valves.

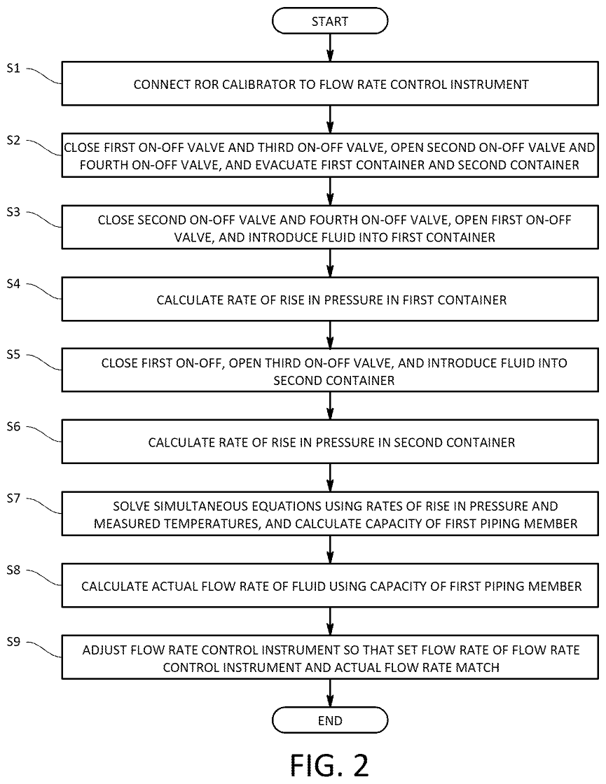

Next, the calibration method of the present embodiment will be described with reference to the flowchart of FIG. 2.

First, the calibrator 10 is connected to the flow rate control instrument MFC, which is the target to be calibrated (S1).

Next, the suction pump P is activated with the first on-off valve X1 and the third on-off valve X3 closed and the second on-off valve X2 and the fourth on-off valve X4 open. Accordingly, the first container 11 and the second container 12 are evacuated (S2).

Thereafter, the second on-off valve X2 and the fourth on-off valve X4 are closed, the first on-off valve X1 is opened, and a fluid controlled by the flow rate control instrument MFC to a set flow rate is introduced into the first container 11 (S3). Accordingly, the pressure in the first container 11 increases gradually. At this time, a signal indicating the measured pressure is sequentially output from the first pressure meter P1 to the information processing apparatus 20, and a signal indicating the measured temperature is sequentially output from the first thermometer T1 to the information processing apparatus 20.

Subsequently, the information processing apparatus 20 calculates the time rate of change in pressure in the first container 11, which is more specifically the rate of rise in pressure dp/dt, on the basis of the measured pressures of the first pressure meter P1 (S4). Note that S3 and S4 correspond to a first calculation step in the claims.

Here, the measured pressures are obtained and stored at a plurality of time points after the elapse of a certain first standby time from the time point at which the first on-off valve X1 is opened in S3, the approximate expression of these measured pressures is obtained by, for example, the least squares method, and the slope of the approximate expression is calculated as the rate of rise in pressure. Note that the first standby time is a period of time estimated to be required for the rate of rise in pressure to be stabilized after the opening of the first on-off valve X1, and the user is allowed to set the first standby time appropriately.

Next, the first on-off valve X1 is closed and the third on-off valve X3 is opened, and a fluid controlled by the flow rate control instrument MFC to a set flow rate is introduced into the second container 12 (S5). Accordingly, the pressure in the second container 12 increases gradually. At this time, a signal indicating the measured pressure is sequentially output from the second pressure meter P2 to the information processing apparatus 20, and a signal indicating the measured temperature is sequentially output from the second thermometer T2 to the information processing apparatus 20.

Note that the set flow rate of the flow rate control instrument MFC in S5 mentioned here and the set flow rate of the flow rate control instrument MFC in S3 described above are the same flow rate.

Subsequently, the information processing apparatus 20 calculates the time rate of change in pressure in the second container 12, which is more specifically the rate of rise in pressure dp/dt, on the basis of the measured pressures of the second pressure meter P2 (S6). Note that S5 and S6 correspond to a second calculation step in the claims.

Here, the measured pressures are obtained and stored at a plurality of time points after the elapse of a certain second standby time from the time point at which the third on-off valve X3 is opened in S5, the approximate expression of these measured pressures is obtained by, for example, the least squares method, and the slope of the approximate expression is calculated as the rate of rise in pressure. Note that the second standby time is a period of time estimated to be required for the rate of rise in pressure to be stabilized after the opening of the third on-off valve X3. The second standby time may be the same as or different from the above-mentioned first standby time, and may be appropriately set by the user.

Then, the information processing apparatus 20 calculates the capacity of the piping member L using the measured temperatures output from the first thermometer T1 and the second thermometer T2 in S3 and S5 and the rates of rise in pressure calculated in S4 and S6 (S7: pipe capacity calculation step).

More specifically, the flow rate Q[SLM] of a fluid may be expressed by the following equation using the gas state equation or the like.

$$\begin{matrix}[ Eq . 2 ] & \\ Q = \frac{d p}{d t} \times V \times \frac{60}{760} \times \frac{273.15}{273.15 + T} \times {C}_{comp} \times {C}_{KFF} & ( 2 )\end{matrix}$$

Note that V is the volume [L] of the fluid, dp/dt is the rate of rise in pressure [Torr/s], T is the temperature [K] of the fluid, C_{comp} is a correction coefficient for the compressibility coefficient of the fluid, and C_{KFF} is a correction coefficient due to the apparatus. Hereinafter, let C_{comp}=1 and C_{KFF}=1 for convenience of explanation.

Here, let the combined capacity of the capacity from the inlet port B to the connection point C between the first branch pipe Z2a and the first container 11, the capacity of the first container 11, and the capacity from the first container 11 to the second on-off valve X2 be V1. In addition, let the combined capacity of the capacity from the inlet port B to the connection point D between the second branch pipe Z2b and the second container 12, the capacity of the second container 12, and the capacity from the second container 12 to the fourth on-off valve X4 be V2. Furthermore, let X be the capacity of the piping member L. Note that V1 and V2 are known, and X is an unknown.

The flow rate of the fluid in S3 is expressed by equation (3) mentioned below by substituting V1+X, which is the capacity of a space into which the fluid is introduced, for V in equation (2) mentioned above.

$$\begin{matrix}[ Eq . 3 ] & \\ Q = {( \frac{d p}{d t} )}_{1} \times ( V 1 + X ) \times {C}_{1} & ( 3 )\end{matrix}$$

Note that C₁=(60/760)×(273.15/273.15+T₁), and T₁ is the temperature inside the first container 11 measured in S3, which is specifically the average value of temperatures measured in S3 or the temperature measured at a certain time point in S3. In addition, (dp/dt)₁ is the rate of rise in pressure calculated in S4.

In contrast, the flow rate of the fluid in S5 is expressed by equation (4) mentioned below by substituting V2+X, which is the capacity of a space into which the fluid is introduced, for V in equation (2) mentioned above.

$$\begin{matrix}[ Eq . 4 ] & \\ Q = {( \frac{d p}{d t} )}_{2} \times ( V 2 + X ) \times {C}_{2} & ( 4 )\end{matrix}$$

Note that C₂=(60/760)×(273.15/273.15+T₂), and T₂ is the temperature inside the first container 11 measured in S5, which is specifically the average value of temperatures measured in S5 or the temperature measured at a certain time point in S5. In addition, (dp/dt)₂ is the rate of rise in pressure calculated in S6.

Here, since the set flow rate in S5 and the set flow rate in S3 are the same as described above, the actual flow rate Q in equation (3)=the actual flow rate in equation (4), and, when the simultaneous equations (3) and (4) under this condition are solved for the unknown X, X is expressed by equation (5) below.

$$\begin{matrix}[ Eq . 5 ] & \\ X = \frac{{{C}_{1} ( \frac{d p}{d l} )}_{1} \cdot {V}_{1} - {{C}_{\underline{7}} ( \frac{d p}{dt} )}_{2} \cdot {V}_{2}}{{{C}_{2} ( \frac{d p}{d t} )}_{2} - {{C}_{1} ( \frac{d p}{d t} )}_{1}} & ( 5 )\end{matrix}$$

Because V1 and V2 are known in equation (5), and (dp/dt)₁, (dp/dt)₂, C₁, and C₂ are the actually measured values regarding temperature, the capacity X of the piping member L may be calculated.

After that, the information processing apparatus 20 substitutes the capacity X of the piping member L into equation (2), equation (3), or equation (4) to calculate the actual flow rate Q (S8: actual flow rate calculation step). Note that the calculated actual flow rate is, for example, displayed and output on a display or the like.

Accordingly, the flow rate control instrument MFC is adjusted by calibrating the actual flow rate Q and the set flow rate of the flow rate control instrument MFC so that the actual flow rate Q and the set flow rate match (S9).

According to such a calibration method, because a fluid whose flow rate is controlled by the flow rate control instrument MFC is introduced into the first container 11 and the second container 12 having different capacities, and the rate of rise in pressure in each of the first container 11 and the second container 12 is separately calculated, simultaneous equations (equations 3 and 4 in the present embodiment) in which the actual flow rate Q of the fluid and the capacity X of the piping member L are unknowns may be obtained using these pressure rates of rise. By solving the simultaneous equations for the capacity X of the piping member L, the capacity X of the piping member L may be easily obtained without providing, for example, a pressure meter, a thermometer, and the like for the piping member L.

As a result, the actual flow rate of the fluid may be calculated in consideration of the capacity of the piping member L, thereby easily and accurately adjusting the flow rate control instrument MFC.

Note that the present invention is not limited to the above-described embodiment.

For example, although the first container 11 and the second container 12 having different capacities are connected in parallel in the above-described embodiment, the capacity of a container may be made changeable using, for example, a partition member or the like.

In this way, the number of containers may be reduced, which results in size reduction of the calibrator 10.

In addition, in S3 of the above-described embodiment, an approximate expression of the measured pressures obtained at a plurality of time points is obtained by using, for example, the least squares method, and the slope of the approximate expression is calculated as the rate of rise in pressure. Alternatively, the rate of rise in pressure may be calculated by obtaining the measured pressures at a first time point after the elapse of the certain first standby time from the time point at which the first on-off valve X1 is opened in S3 and at a second time point after the first time point, and by dividing the difference between the measured pressure at the first time point and the measured pressure at the second time point by the time from the first time point to the second time point.

Note that the same applies to S5 in the above-described embodiment.

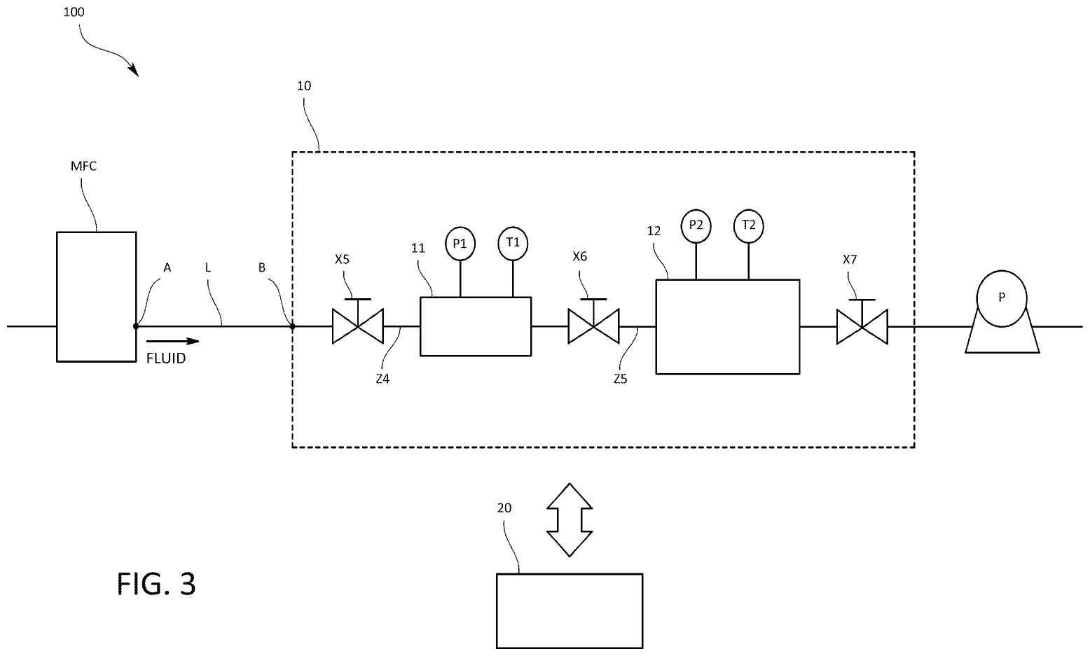

Furthermore, as the calibrator 10, as illustrated in FIG. 3, a plurality of containers may be connected in series.

Specifically, this calibrator 10 includes a first pipe Z4, the first container 11, a second pipe Z5, and the second container 12 which are connected in series in this order. A fifth on-off valve X5 is provided upstream of the first container 11, a sixth on-off valve X6 is provided between the first container 11 and the second container 12, and a seventh on-off valve X7 is provided downstream of the second container 12. Note that the first pipe Z4 and the second pipe Z5 have known capacities.

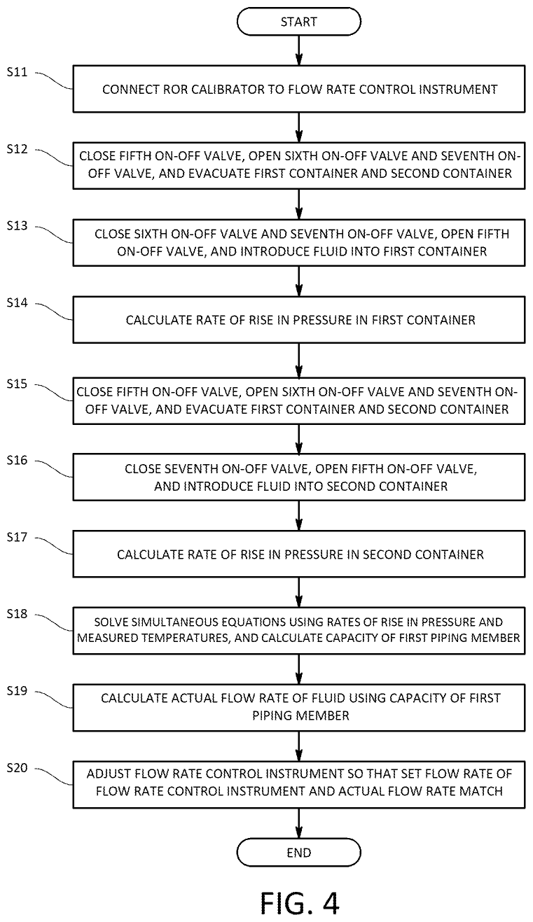

As a calibration method using this calibrator 10, as illustrated in FIG. 4, the calibrator 10 is connected to the flow rate control instrument MFC (S11); and, the fifth on-off valve X5 is closed, the sixth on-off valve X6 and the seventh on-off valve X7 are opened, and the first container 11 and the second container 12 are evacuated (S12).

After that, the sixth on-off valve X6 and the seventh on-off valve X7 are closed, the fifth on-off valve X5 is opened, and a fluid controlled by a fluid control instrument to a set flow rate is introduced only into the first container 11 (S13), and the rate of rise in pressure in the first container 11 is calculated (S14).

Next, the fifth on-off valve X5 is closed, the sixth on-off valve X6 and the seventh on-off valve X7 are opened, and the first container 11 and the second container 12 are evacuated again (S15).

After that, the seventh on-off valve X7 is closed, the fifth on-off valve X5 is opened with the sixth on-off valve X6 open, and a fluid controlled by the fluid control instrument to a set flow rate is introduced into the first container 11 and the second container 12 (S16); and the rate of rise in pressure in the second container 12 is calculated (S17). Thereafter, the flow rate control instrument MFC may be adjusted in the same manner as in the above embodiment (S18 to 20).

Even with this method, as in the above-described embodiment, simultaneous equations in which the actual flow rate Q of the fluid and the capacity X of the piping member L are unknowns may be obtained, and the capacity X of the piping member L may be easily obtained.

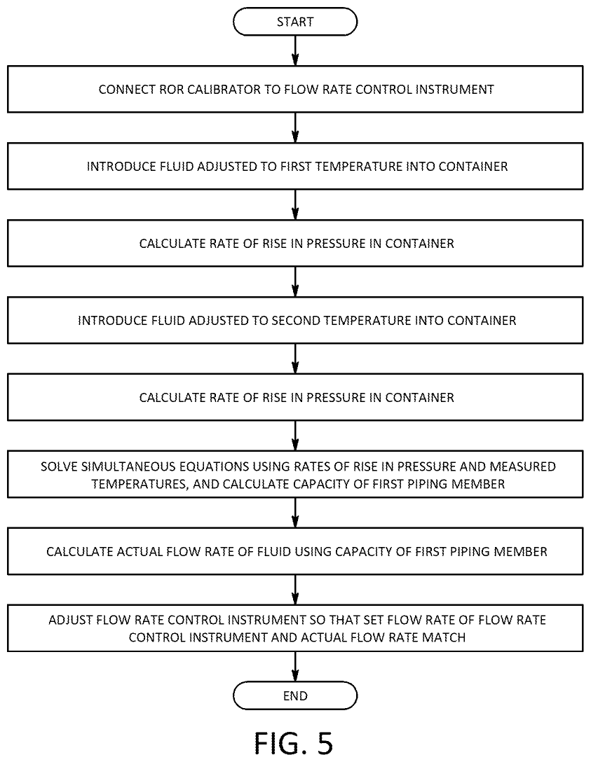

Another calibration method may be as follows, as illustrated in FIG. 5: a fluid controlled by the flow rate control instrument to a set flow rate is adjusted to a certain first temperature and introduced into a container, and the rate of rise in pressure in the container is calculated; and, after that, a fluid controlled by the flow rate control instrument to the set flow rate is adjusted to a second temperature different from the first temperature and introduced into the container, and the rate of rise in pressure in the container is calculated.

In this case, by substituting the first temperature and the second temperature for the value of T in equation (2) in the above-described embodiment, under the condition that the actual flow rates Q obtained as a result thereof are the same, simultaneous equations in which the actual flow rate Q of the fluid and the capacity X of the piping member L are unknowns may be obtained.

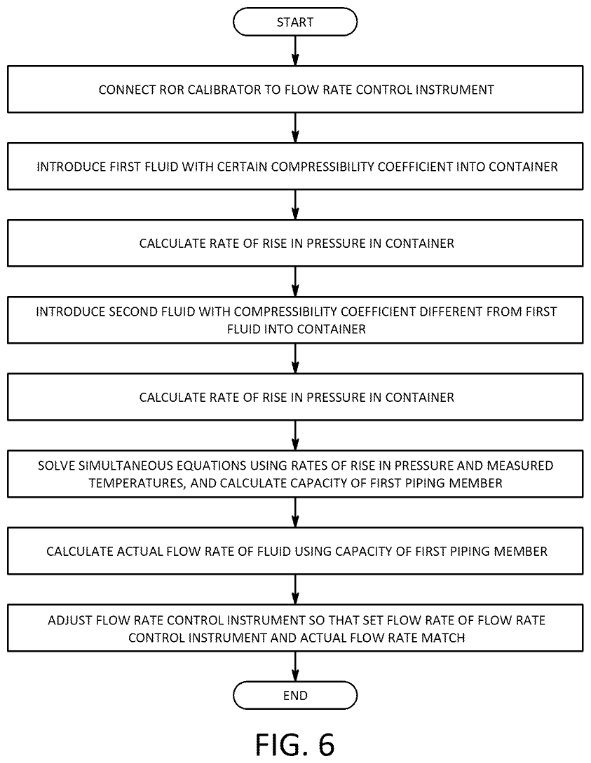

Yet another calibration method may be as follows, as illustrated in FIG. 6: a first fluid with a certain compressibility coefficient is controlled by the flow rate control instrument to a set flow rate and introduced into a container, and the rate of rise in pressure in the container is calculated; and, after that, a second fluid with a compressibility coefficient different from the first fluid is controlled by the flow rate control instrument to the set flow rate and introduced into the container, and the rate of rise in pressure in the container is calculated.

In this case, by substituting the correction coefficients for the compressibility coefficients of the first fluid and the second fluid for the value of C_{comp} in equation (2) in the above-described embodiment, under the condition that the actual flow rates Q obtained as a result thereof are the same, simultaneous equations in which the actual flow rate Q of the fluid and the capacity X of the piping member L are unknowns may be obtained, as in the above-described embodiment.

Even with the methods illustrated in FIGS. 5 and 6, the capacity of the piping member may be easily obtained, and, moreover, the number of required containers may be one, thereby reducing the size of the calibrator.

In addition, instead of changing only one parameter of the capacity of the capacity, the number of containers, the temperature of the fluid, and the type of the fluid in the first calculation step and the second calculation step, a plurality of parameters thereof may be changed.

Furthermore, although the flow rate control instrument is the target to be calibrated in the above-described embodiment, the calibration method and calibration device according to the present invention may be applied to, for example, the calibration of a flow rate measuring instrument (mass flow meter).

In this case, the flow rate measuring instrument may be adjusted by calibrating the measured value measured by the flow rate measuring instrument and the actual flow rate Q calculated in the same manner as in the above-described embodiment so that the actual flow rate Q and the measured value match.

Besides that, the present invention is not limited to the above-described embodiments, and, needless to say, various modifications may be made within the range not departing from the spirit of the present invention.

### REFERENCE CHARACTERS LIST

100 . . . calibration system
MFC . . . flow rate control instrument
10 . . . calibrator
20 . . . information processing apparatus 20
P . . . suction pump
L . . . piping member
11 . . . first container
12 . . . second container
X1 . . . first on-off valve
X2 . . . second on-off valve
X3 . . . third on-off valve
X4 . . . fourth on-off valve
P1 . . . first pressure meter
T1 . . . first thermometer
P2 . . . second pressure meter
T2 . . . second thermometer

### INDUSTRIAL APPLICABILITY

According to the present invention, a flow rate control instrument or a flow rate measuring instrument may be calibrated more easily and accurately as compared to the related art.

1. A calculation method comprising:
a first calculation step of introducing a fluid controlled by a flow rate control instrument to a certain set flow rate into a container via a piping member and calculating a time rate of change in pressure in the container;
a second calculation step of introducing a fluid controlled by the flow rate control instrument to the set flow rate into a container via a piping member while making any of a capacity of the container into which the fluid is introduced, a number of containers into which the fluid is introduced, a temperature of the fluid, and a type of the fluid different from the first calculation step, and calculating a time rate of change in pressure in the container; and
a pipe capacity calculation step of calculating a capacity of the piping member based on the time rate of change in pressure calculated in the first calculation step and the time rate of change in pressure calculated in the second calculation step.

2. The calculation method according to claim 1, wherein:
a first container and a second container having different capacities are connected in parallel,
in the first calculation step, a fluid controlled by the flow rate control instrument to the set flow rate is introduced into the first container without being introduced into the second container, and
in the second calculation step, a fluid controlled by the flow rate control instrument to the set flow rate is introduced into the second container without being introduced into the first container.

3. The calculation method according to claim 1, wherein:
a first container and a second container are connected in series,
in the first calculation step, a fluid controlled by the flow rate control instrument to the set flow rate is introduced into the first container without being introduced into the second container, and
in the second calculation step, a fluid controlled by the flow rate control instrument to the set flow rate is introduced into the first container and the second container.

4. The calculation method according to claim 1, further comprising an actual flow rate calculation step of calculating an actual flow rate of the fluid controlled by the flow rate control instrument using the capacity of the piping member calculated in the pipe capacity calculation step.

5. A calibrator to which a flow rate control instrument is connected with a piping member interposed therebetween, comprising:
at least two containers into which a fluid controlled by the flow rate control instrument to a certain set flow rate is introduced,
wherein a capacity of a container or a number of containers into which a fluid controlled by the flow rate control instrument to the set flow rate is introduced is configured to be changeable.

6. A calculation method comprising:
a first calculation step of introducing a fluid whose flow rate is measured by a flow rate measuring instrument into a container via a piping member and calculating a time rate of change in pressure in the container;
a second calculation step of introducing a fluid whose flow rate is measured by the flow rate measuring instrument into a container via a piping member while making any of a capacity of the container into which the fluid is introduced, a number of containers into which the fluid is introduced, a temperature of the fluid, and a type of the fluid different from the first calculation step, and calculating a time rate of change in pressure in the container; and
a pipe capacity calculation step of calculating a capacity of the piping member based on the time rate of change in pressure calculated in the first calculation step and the time rate of change in pressure calculated in the second calculation step.
